(19) United States
(12) Patent Application Publication
(10) Pub. No.: US 2015/0126118 A1
(43) Pub. Date: May 7, 2015

(54) Method and apparatus for intention based contactless device pairing

(71) Applicants: Peisen Lin, Singapore (SG); Haiqin Huang, Beijing (CN); Usman Younas, Sheikhupura (PK)

(72) Inventors: Peisen Lin, Singapore (SG); Haiqin Huang, Beijing (CN); Usman Younas, Sheikhupura (PK)

(21) Appl. No.: 14/073,893

(22) Filed: Nov. 7, 2013

(51) Int. Cl. H04W 76/02

(52) U.S. Cl. CPC H04W 76/023
USPC 455/41.2

(57) ABSTRACT

A method for intention based contactless device pairing. An intention based contactless device pairing occurs when a first devices is sufficiently close to a second device/object and is pointing sufficiently opposite in direction to the second device/object. A process for validating the device pairing is described.

This invention relates to the field of establishing communications between devices.

### BACKGROUND

A prerequisite for a truly magical in-situ contactless device pairing is intention based—a device pairing method that acts upon the user's intention to connect to an intended device or object without prior engagement requirements. What's needed is an effective method to capture the user's intention in a multi-party setting where there are a plurality of candidate devices nearby, and selecting exactly which device the user intends to establish a connection with. In a motivating example, an user who wants to pair up his/her device to a nearby object or with another device simply identify the intended target in mind, do a simple ‘point’ gesture in the direction of the intended target, and initiates a pairing request. The pairing request pairs with the intended object or targeted device within seconds.

What's required for this form of in-situ, intention-based contactless device pairing is a rigorous method that lets the device know exactly which object in proximity is indeed the intended target. This involves bridging a “perception gap” between the user and the device, wherein a user knows clearly in mind what the intended target is, but the device must translate that into a piece of identifiable information understandable at the machine level. We will see how this “perception gap” can be further minimized with this method of intention based device pairing paradigm. It is based on the ability for the user to express, and the system to capture, the intention of the user and predicts exactly which devices should pair up.

### BRIEF DESCRIPTION OF THE DRAWINGS

FIG. 1 illustrates two mobile devices, a device 110 and a device 120 owned by two users who want to establish a connection, point at opposite directions and initiate a pairing request.

FIG. 2 shows a schematic diagram of communications between a pairing device 210 and a server 200 when the pairing request has been initiated.

FIG. 3 shows a schematic diagram illustrating the computation process that takes an incoming pairing information 300 at the server 200, and returning an user intention result 350 to device 210.

FIG. 4 shows a user's perspective of three dimensional space.

FIG. 5 shows a device's perspective of three dimensional space

FIG. 6 illustrates the perception gap due to device's perspective of the three dimensional space

FIG. 7 summarizes the problem of “perception gap” of the device's perceived three dimensional space.

FIG. 8 illustrates how the “perception gap” can be bridged by first adding an object facing direction, f, to the object, and then compute a relative distance and a relative direction between the device and the object.

FIG. 9A illustrates an ideal case of “Pairing Valid” between a connecting device D, and another device or object D′.

FIG. 9B illustrates another ideal case of “Pairing Valid” between a connecting device D, and another device or object D′.

FIG. 10A illustrates an ideal case of “Pairing invalid” between a device D and another device or object D′.

FIG. 10B illustrates another ideal case of “Pairing invalid” between a device D and another device or object D′.

FIG. 11 illustrates the step procedure for deriving the user intention predictive model 340 using a logistic regression.

Table 12 illustrates an example of table that comprises of predictor input X1, and X2, with its corresponding assignment of output, Y.

FIG. 13 illustrates the result of a sigmoid function generated using logistic regression.

FIG. 14 illustrates the complete step process of intention-based device pairing validation.

### DETAILED DESCRIPTION

The present invention relates to a method of intention-based contactless device pairing. The intention-based contactless device pairing occurs when a device, owned by a user who wants to establish a contactless connection with an intended device or object nearby, points in the direction of the intended device or object, and initiates a pairing request. An intention-based contactless pairing system is programmed to capture the user's intended pairing device or object, compute a pairing predictive score based on a relative location value and a relative direction value with respect to a plurality of candidate devices or objects nearby, determine the maximum likelihood of a correctly predicted device pairing, pick the correct user intended device or object among the plurality of candidate devices or objects nearby and complete the pairing.

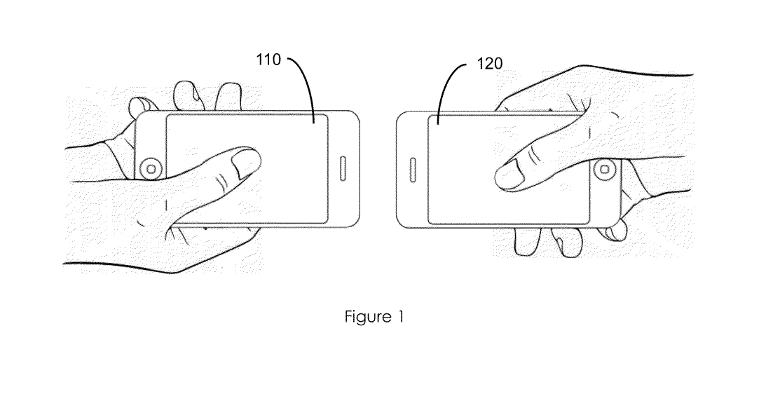

FIG. 1 illustrates two mobile devices, a device 110 and a device 120 owned by two users who want to establish a connection, point at opposite directions and initiate a pairing request. The pairing request may be initiated by an asynchronous button press, voice command, audio sound, gestures, or any other methods capable of alerting the device 110 or the device 120 to initiate the pairing request. The pairing request may be initiated asynchronously, and is hence not necessarily a simultaneous gesture or synchronous event. The pairing request may be initiated by a mobile phone, wearable device, personal computer, laptop or other electronic devices capable of reporting the current location of the device, and the current direction or orientation of the device.

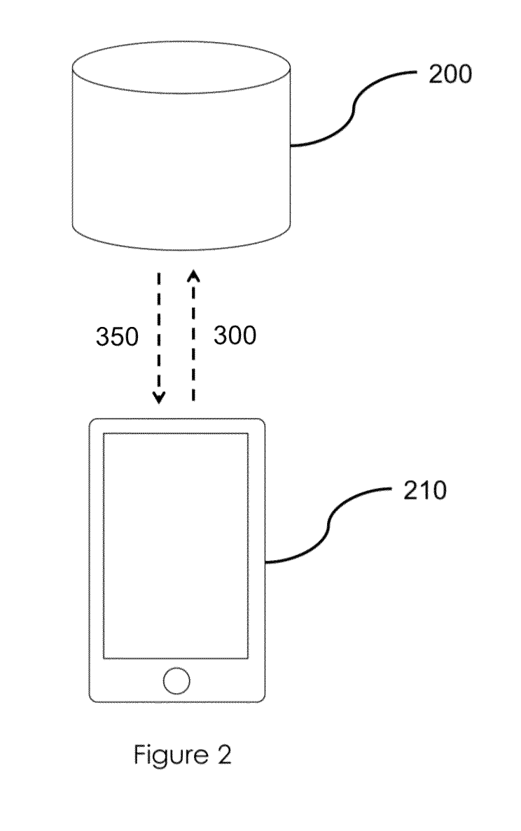

FIG. 2 shows a schematic diagram of communications between a pairing device 210 and a server 200 when the pairing request has been initiated. In FIG. 2, the device 210 is in communication with the server 200 by sending a pairing information 300 to the server 200, and the server 200 returning a user intention result 350 to device 210 to inform device 210 on the most probable prediction of the user's pairing intention. A valid intention-based pairing occurs when the user intention result 350 contains at least one satisfactory candidate device or object that has a pairing probability greater than a threshold probability. The threshold probability is a benchmark that differentiates the odds of a case correctly predicting the user's pairing intention with the targeted device or object to the odds of a case incorrectly predicting the targeted device or object. If there exists no satisfactory candidate device or object that has a pairing probability greater than the threshold probability, the server 200 loops and waits for a new incoming pairing information from another device that would satisfy the threshold probability. The process that validates the intention of the user to pair up with exactly which intended device or objects is called intention-based pairing validation. A method for quantizing intention-based pairing validation is the subject of much of the description here. Indeed, what is considered an intended pairing? How do we quantize an user's intention to pair with exactly which device? We will discuss a rigorous method that quantizes an user's pairing intention to connect with exactly which device nearby by measuring the odds of correctly predicting that user's intrinsic intention.

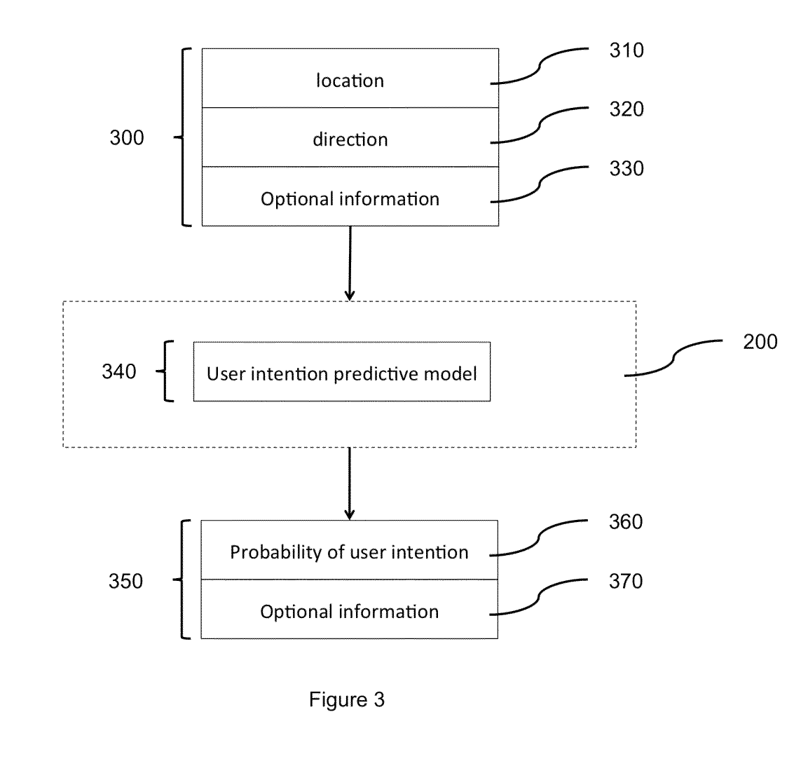

FIG. 3 shows a schematic diagram illustrating the computation process that takes an incoming pairing information 300 at the server 200, and returning an user intention result 350 to device 210. When a pairing request is successfully initiated by the device 210, the device 210 sends the pairing information 300 to the server 200. The pairing information 300 may comprise of a location 310, a direction 320 and optional information 330. The location 310 is the current location of the device, which may be obtained from the built-in global positioning system (GPS) sensor. The location 310 may be a GPS coordinate (longitude, latitude, and optionally altitude) or a name of a physical location, or a physical address, an internet protocol (IP) address, or any other data capable of representing a physical location. The direction 320 is the direction at which the device is pointing to, or facing at, or oriented to a reference angle commonly known Azimuth or North bearing. The direction 320 may be captured by the device's built-in compass, direction sensor, or any other instruments capable of telling the orientation of the device. The optional information 330 is additional information that may be obtained from the device's built-in sensors including but not limited to Ambient Light Sensor (ALS) that detects surrounding ambient light, Proximity Sensor (PS) that detects how close the device is to another foreign object, Sound Detector that detectors sound, Accelerometer that detects the orientation of the device and tells its perspective of how it is moved, Gyroscope that detects the motion sensing or measures angular momentum etc.

In FIG. 3, upon receiving the pairing information 300 at the server 200, an user intention predictive model 340 takes the incoming pairing information 300 and returns a user intention result 350, which may comprise of a pairing probability 360 and an optional information 370. The pairing probability 360 is the probability of the odds of correctly predicting the user's intention to pair with a particular device or object nearby. The optional information 370 may comprises of additional information such as the candidate user identification number, name of user, etc. A method of constructing the user intention predictive model 340 and a method using the user intention predictive model 340 to compute the user intention result 350 using the pairing information 300 will be discussed in greater details at later parts. Now, let us take a more detailed discussion at the problem of determining a “user's intrinsic intention”. Indeed, what is meant by “user's intrinsic intention”. The need for a detailed discussion of this issue comes from the limitations of a typical device's ability to deduce an user intention. While we could attempt to measure the user's intention based on the location 310 value and the direction 320 values of pairing information 300, the location 310 value and the direction 320 value, however, are inherently limited by the device's ability to provide accurate readings of its location and direction. Let's us examine what are the challenges of predicting a user's intention based on these inaccurate location and direction sensor readings.

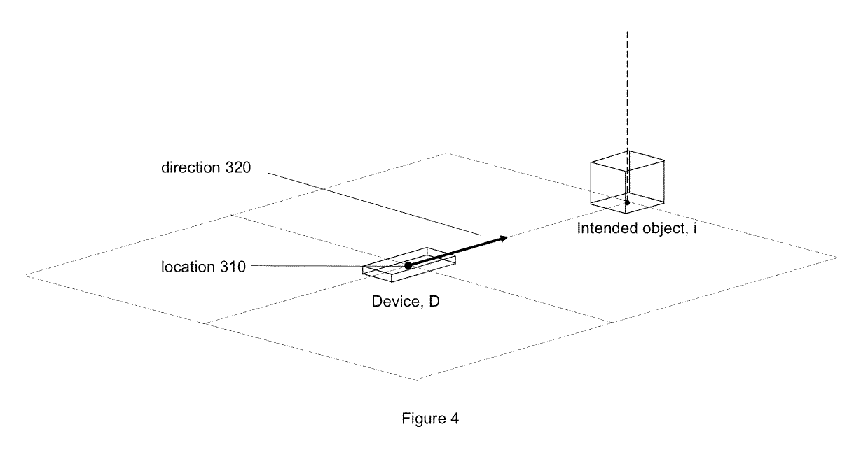

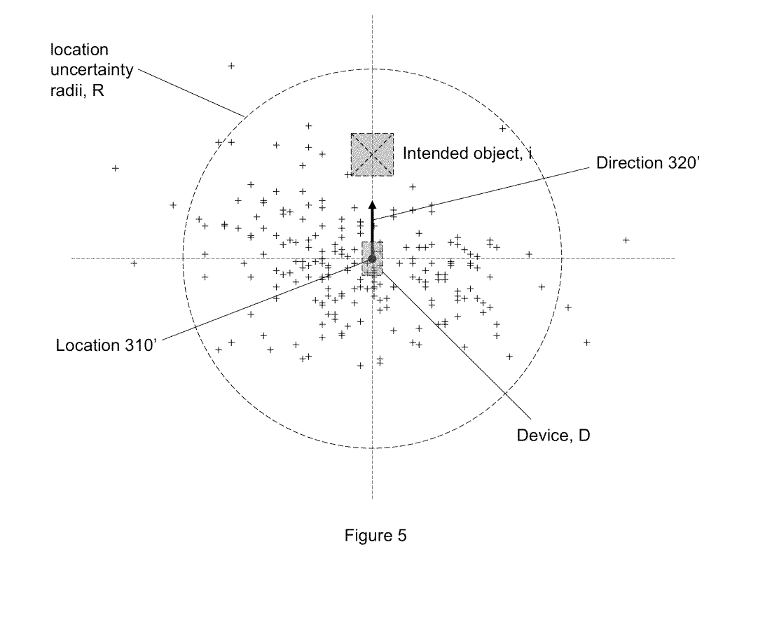

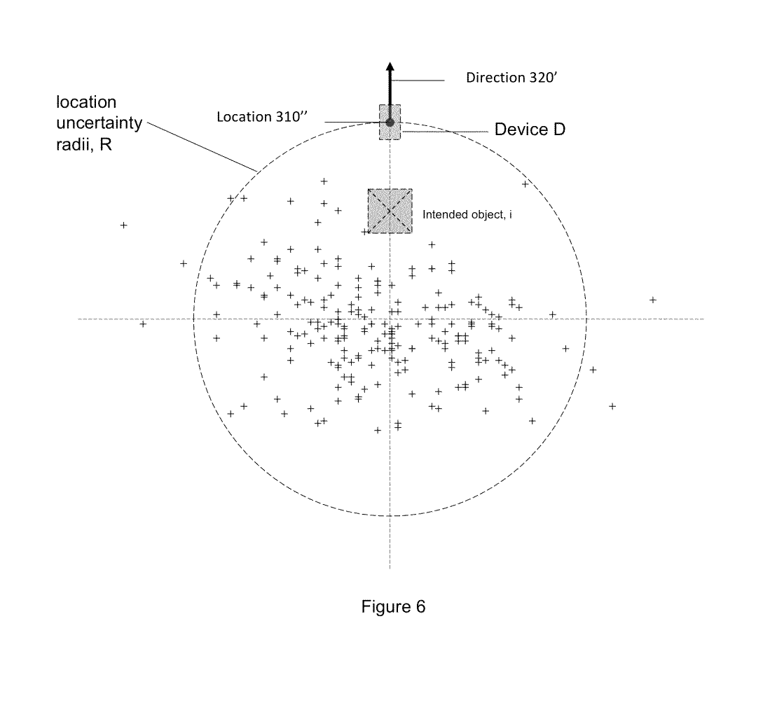

The problem with deducing an “user's intrinsic intention” through a device is that there exist a “perception gap” between the user's perceived three dimensional space and the device's perceived three dimensional space. For instance, an user is capable-of seeing an intended pairing device or object physically located at a three dimensional location, but the devices are not capable of “seeing” the intended pairing device or object physically located in the three dimensional location, instead, the device typically perceives the three dimensional space with an approximated measurement of location using GPS sensors bounded by an uncertainty radius. To understand this “perception gap”, let us illustrate it with a two simple comparisons. FIG. 4 shows a user's perspective of three dimensional space, while FIG. 5 shows a device's perspective of three dimensional space. In FIG. 4, the user's three dimensional perspective is able to “see” device D physically located at location 310, pointing in a direction 320 at an intended object, i. In this three dimensional user perspective, the “user's intrinsic intention” is straightforward—the user wants to connect the device D to the intended object, i, as interpreted by the user's pointing direction at the intended object, i. But in the device's perspective as illustrated in FIG. 5, the device D typically ‘sees’ an estimate of its current location, a location 310′, bounded by a location uncertainty radii, R. In FIG. 5, a “+” mark is experimentally plotted over time, showing the perceived locations of the device D at different time interval. When these marks are collectively plotted onto a two dimensional plane, it shows a dispersion of location estimates spread within an encircled boundary within the location uncertainty radii, R. The spread in location estimate arise due to the limited ability of a typical device in estimating its current location. Let us examine the consequence of attempting to interpret an “user's intrinsic intention” given the limitation of the device's perceived three dimensional space. In FIG. 5, suppose the device D perceives itself to be physically located at the location 310′—i.e., the ‘centre’ of the location uncertainty radii, R, and is pointing at the direction 320′. This set of information when physically interpreted would certainly allow the device D to draw a conclusion that it is indeed “pointing at” the intended object, i. But what if the device D perceives itself to be located at another possible location within the location uncertainty radii, R, as illustrated in FIG. 6. In FIG. 6, the device D perceives itself to be located at location 310″—i.e., the ‘boundary’ of the location uncertainty radii, R, but is however also pointing at the direction 320′. Device D would then conclude that it is “pointing away” from the intended object, i, and this contradicts with the earlier conclusion of “point at” the intended object, i. The existence of this “perception gap” at which the limitation of the device's ability to report accurate location and accurate direction causes confusion in interpretating an “user's intrinsic intention”. To overcome this problem, a novel method that bridges this “perception gap” between the user's perceived three dimensional space and the device's perceived three dimensional space is constructed. The intention predictive model 340 is thus made to achieve the goal of quantizing pairing intention that could tolerate the limitation of a typical device's ability to estimate both location and direction. It would be the aim of the user intention predictive model 340 to bridge this “perception gap” between humans and machines and convert the pairing information 300 into a quantifiable value that tells specifically what value of probability is the user's intrinsic intention to connect with exactly which device nearby.

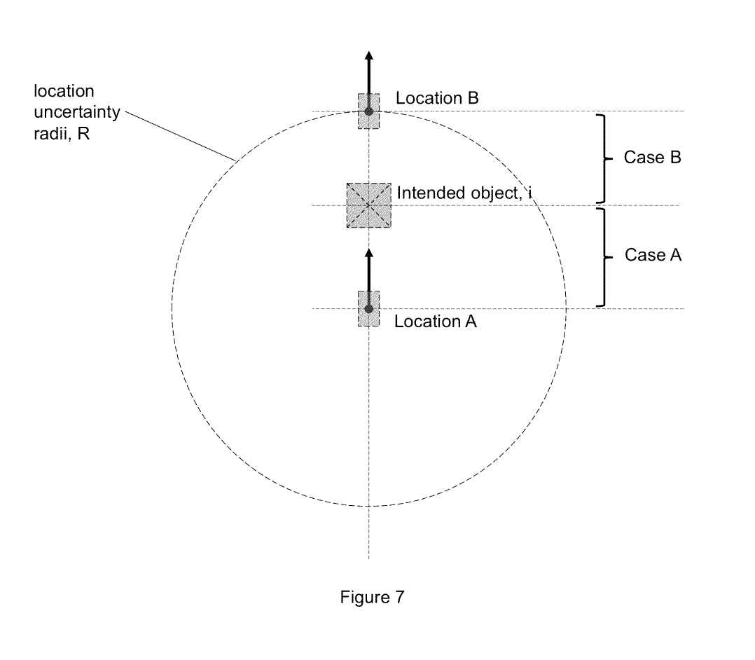

FIG. 7 summarizes the problem of “perception gap” of the device's perceived three dimensional space. In FIG. 7, the location uncertainty radii, R, encircles all possible locations at which the device could possibly be located with respect to its true location. A rigourous method is thus required to solve, for example, if the device is perceived to be located at location A with respect to the intended object, i, labelled as “case A” in FIG. 7, and also if the device is perceived to be located at location B with respect to the intended object, i, labelled as “case B” in FIG. 7. Both “case A” and “case B” should return similar predictions on the “user's intrinsic intention” because in an user intended pairing scenario, a user stands in stationary and points the device in an exact direction to the intended object, i, to initiate a pairing request. The “perception gap” exist because of the inherent limitation of device's ability to estimate location and direction, and hence should return similar predictions on the “user's intrinsic intention”. We have discussed earlier how the “perception gap” makes the physical interpretation of the “user's intrinsic intention” contradictory. We shall discuss how we can close this “perception gap” now.

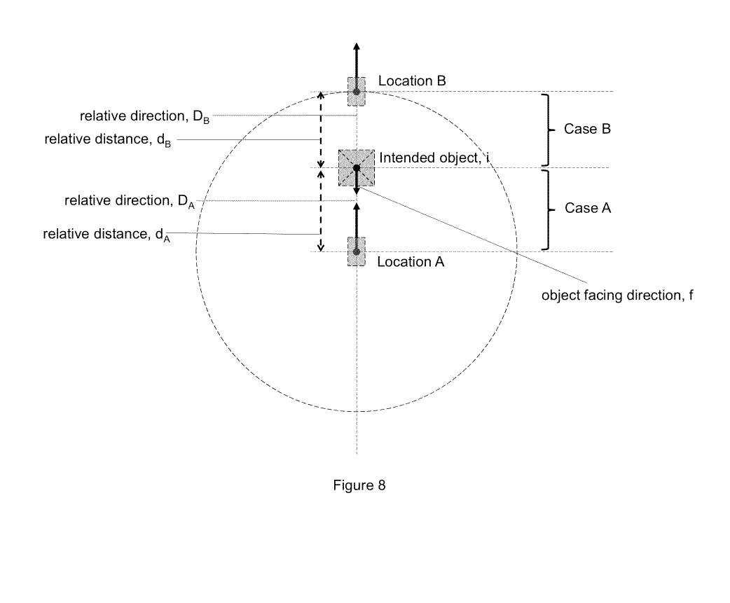

FIG. 8 illustrates how the “perception gap” can be bridged by first adding an object facing direction, f, to the object, and then compute a relative distance and a relative direction between the device and the object. The relative distance and relative direction can then be used as predictor inputs values to calculate a likelihood of the user's intrinsic intention to connect with that object. Let us first understand how the additional of the object facing direction, f, helps to bridge the “perception gap” and nullify the contradictory conclusions of “case A” and “case B” as discussed in FIG. 8, and hence making both cases agree with each other. In FIG. 8, an object facing direction, f, is added to the intended object, i, to even out the “perception gap” of the “user's intrinsic intention”. This is done by computing the relative location and relative direction of the connecting device to the intended object, which will surprisingly turn out to be approximately equivalent. For example, when the device perceives its current location to be arbitrarily located at location A in FIG. 8 with respect to the intended object, i, herein labelled as “case A”, and when the device perceives its current location to be arbitrarily at located at location B with respect to the intended object, i, herein labelled as “case B”, the “perception gap” that initially causes a confusion on whether the device is “pointing at” or “pointing away” from the intended object, i, is now nullified by a common measure of its relative location and relative direction. More specifically, in FIG. 8 “case A”, the relative direction, D_{A}, which is computed to be the relative direction between the device at location A and the object facing direction, f, is equals to 180 degrees. Similarly in FIG. 8 “case B”, the relative direction, D_{B}, which is computed to be the relative direction between the device at location B and the object facing direction, f, is also 180 degrees. As we can see, by first adding an object facing direction, f, we are able to even out the “perception gap” using a common formula. Notice that however, the added object facing direction, f, may be pre-assigned, pre-calibrated, or it can be also be dynamically updated by a device or object capable of sending its current location and/or current direction to a server. For instance, if the intended object, i, is a passive non-electronic device, such as a banner, an advertisement space, a store, a building, a location, or any other physical locations, it may be pre-assigned a location value and a direction value to be stored in a server database. Alternatively, if the intended object, i, is an active electronic device capable of reporting its current location value and current direction value, it may send its updated current location value and current direction value to a server database.

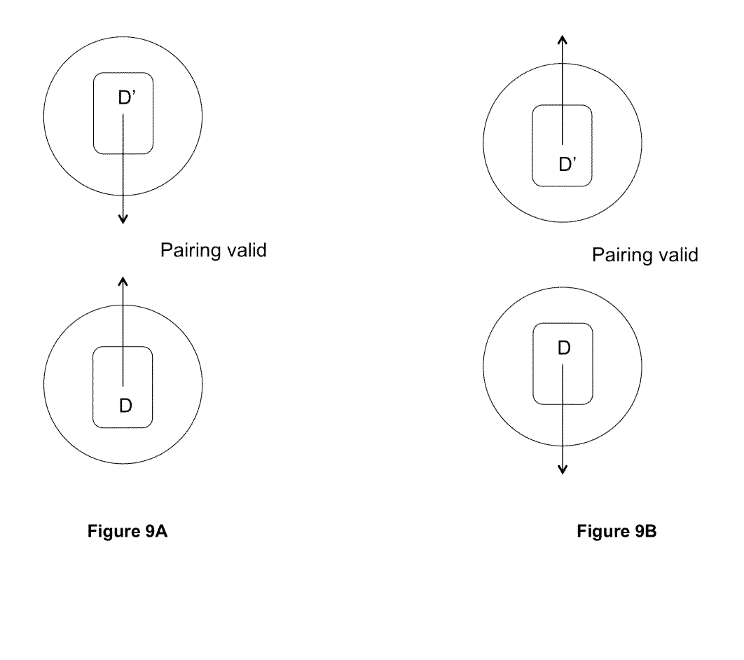

FIG. 9A illustrates an ideal case of “Pairing Valid” between a connecting device D, and another device or object D′. In FIG. 9A, device D is intended to connect with the device or object, D′, and the device or object D′ is also intended to connect with device D. Both the device D and device or object D′ makes a relative direction of approximately “opposite in direction”, i.e., 180 degrees.

FIG. 9B illustrates another ideal case of “Pairing Valid” between a connecting device D, and another device or object D′. In FIG. 9B, device D is intended to connect with the device or object, D′, and the device or object D′ is also intended to connect with device D. Both the device D and device or object D′ makes a relative direction of approximately “opposite in direction”, i.e., 180 degrees. In FIG. 9B, although the device D and device or object D′ seems to be “pointing away” from each other, their computed “relative direction” are however “opposite in direction”, i.e., 180 degrees. Hence it is a “Pairing Valid”. We have discussed earlier in FIG. 8 on how the location uncertainty radii, R, causes a confusion on “perception gap”, and how such “perception gap” can be resolved by taking a common formula on the relative distance and relative angle between the device and the object, and that “case A” as illustrated in FIG. 9A and “case B” as illustrated in FIG. 9B should indeed inherit the same conclusion on the “user's intrinsic Intention” using the same common formula of relative distance and relative direction that is approximately opposite in direction. Therefore, a “Pairing Valid” case may comprise of the case wherein a first device is sufficiently close to a second device/object, and that both the first device and second device/object are pointing in a direction sufficiently opposite to each other.

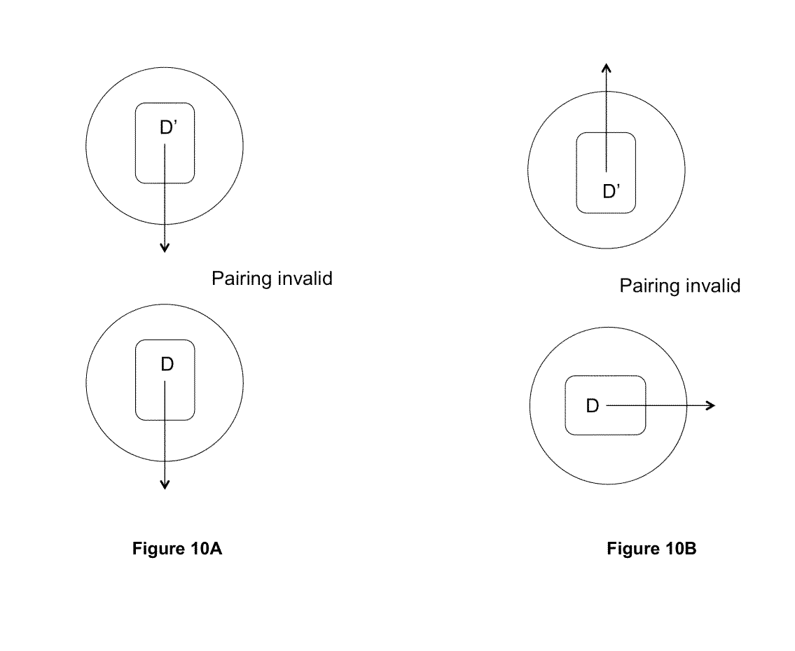

FIG. 10A illustrates an ideal case of “Pairing invalid” between a device D and another device or object D′. In FIG. 10A, device D and the device or object D′ are pointing in the same direction, making a relative direction of approximately 0 degrees. i.e., the devices are not pointing “directly opposite in direction”.

FIG. 10B illustrates another ideal case of “Pairing invalid” between a device D and another device or object D′. In FIG. 10B, device D and the device or object D′ are pointing at a direction that is perpendicular to each other, making a relative direction of approximately “right angle to each other”, i.e., 90 degrees. i.e., the devices are not pointing “directly opposite in direction”.

Now that we have described what comprises of an ideal pairing valid orientations, and ideal pairing invalid orientation, what about non-ideal pairing orientations? Just like how location sensors are limited by its ability to estimate its current location, the direction sensors are also limited by its ability to estimate its current facing direction. While users who intends to connect with each other, try their best to point in exactly opposite direction, the device may not capable of providing the same precision in estimating its current facing direction. For instance, users who intends to connect with each other could well align their devices to be pointing at perfectly 180 degrees, but the devices direction sensor may perceive the pointing angles to be only 135 degrees. What's required is a rigourous method that is able to quantize all possible orientation of device pairing and return a weighted value that best predicts the “user's intrinsic intention”. This is necessary for a robust pairing system to capture all incoming pairing request from users and determine exactly which devices should pair up. To do that, we construct an user intention predictive model 340 to quantize the probability of correctly predicting the “user's intrinsic intention” given the relative distance and relative direction of the pairing devices. This means that, given an arbitrary value of relative distance and an arbitrary value of relative direction between two or more connecting devices and objects, we could compute a numerical probability of “user's intrinsic intention” to pair exactly which device to which device. Since numerical probability typically takes on values between 0.00 to 1.00, we are able to compare two or more pairing requests to determine exactly which device intends to pair to which device simply by pairing up devices with higher probabilities of pairing intentions.

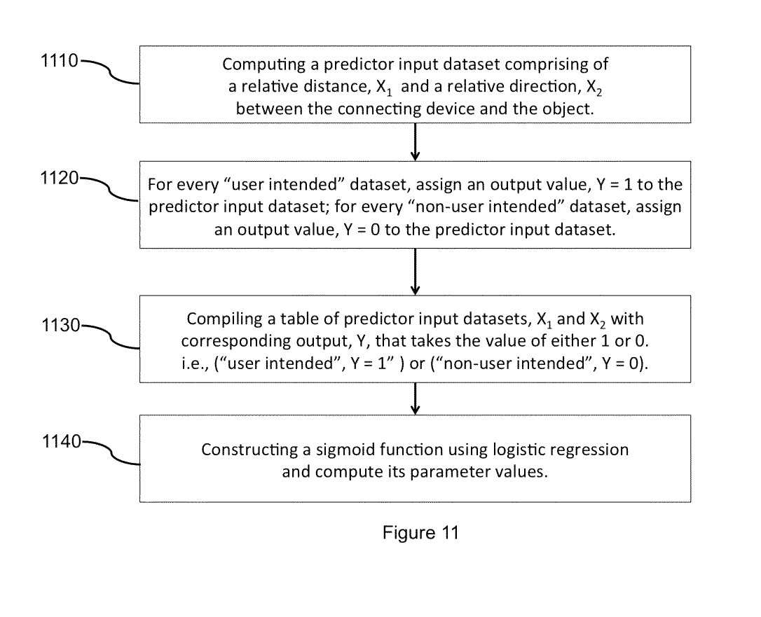

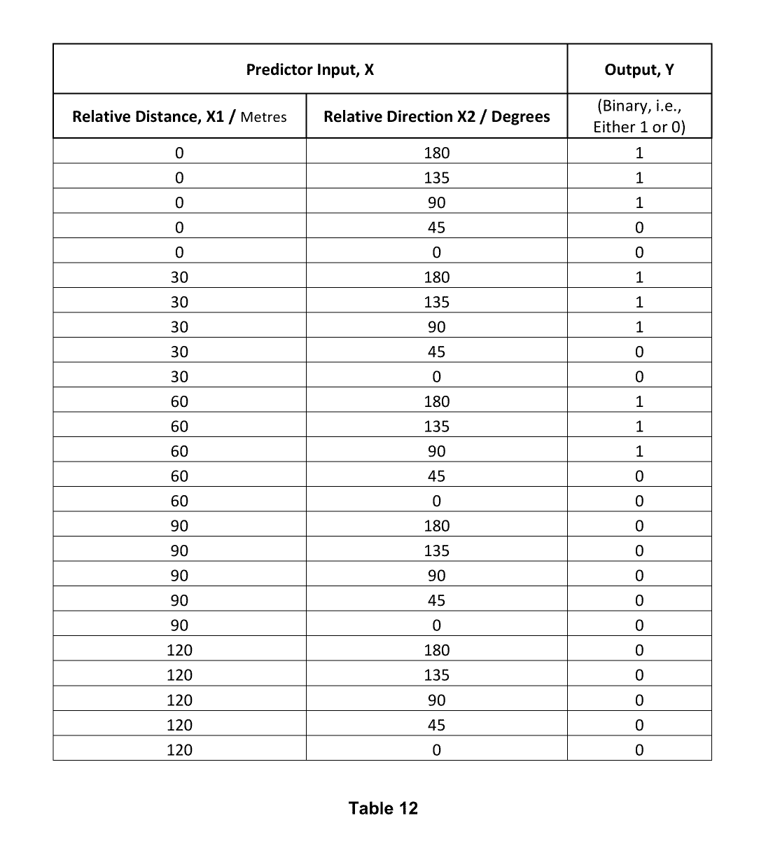

FIG. 11 illustrates the step procedure for deriving the user intention predictive model 340 using a logistic regression. The logistic regression works by assuming probability of an “user intended” device pairing (Y=1) case by taking the probability P(Y=1|x1,x2)=ê{b0+b1X1+b2X2}/(1+ê{b0+b1X1+b2X2}) and P(Y=0|x1,x2)=1/(1+ê{b0+b1X1+b2X2}).

P(Y=1|x1,x2)=ê{b0+b1X1+b2X2}/(1+ê{b0+b1X1+b2X2}) above means the probability of an “user intended” device pairing case, i.e., Y=1, given two predictor inputs X1, X2, wherein the predictor input X1 is the relative location value between two connecting devices and the predictor input X2 is the relative direction value between the two connecting devices. On the other hand, P(Y=0|x1,x2)=1/(1+ê{b0+b1X1+b2X2}) means the probability of a “Non user intended” case, i.e., Y=0, given the same predictor input X1, X2.

The goal is to estimate the parameter values of a logistic sigmoid function, which are the coefficients of predictors input of X1 and X2. Whenever there is a contributing dataset comprising of a set of data containing a predictor input, X1, a predictor input X2 and a known output value, Y, that takes on a binary value of either 1 or 0. i.e., {X1, X2, Y}. Each dataset contributes one term to the likelihood. For example, if there is a dataset of (Relative distance, X1=30 metres, and relative direction, X2=180 degrees, and a known outcome of “User Intended” pairing case, Y=1), then we will have a dataset (X1=30, X2=180, Y=1). This dataset then contributes one term to the likelihood, i.e., we have a contributing term ê{b0+b1*30+b2*180}/(1+ê{b0+b1*30+b2*180}). Thus the likelihood is just the product of all such terms (the number of terms is the same as the number of observations or datasets). One of the goal is to have a sufficient number of datasets that could then be computed in a logistic regression for deducing the relationship of varying relative distance and varying relative direction. i.e., What's the degree of change in probability of pairing per unit increase in relative distance, and what's the degree of change in probability per unit increase in relative direction.

Once we have the likelihood expressed as a function of coefficient values of b0,b1,b2, we can now maximize the likelihood that best estimates the value of b0,b1,b2. There is no close form solution to this optimization problem but we could use numerical algorithms that could generate the maximizer to obtain the estimates in logistic regression. Obtaining the estimates in logistic regression may comprises using Maximum likelihood estimation, Likelihood ratio test, or any other algorithm generating function capable of relating the predictor input values to the output values.

Now that we have discussed the concept of generating the user predictive model 340, we shall now come back to FIG. 11 and discuss the specific details. Step 1110 is “Computing a predictor input dataset comprising of a relative distance, X1 and a relative direction, X2 between the connecting device and the object.”; The predictor input dataset is a set of data that comprises of a relative distance, X1, and a relative distance X2. The relative distance, X1, may be calculated by taking the geographical position differences between the connecting devices. If the locations of the devices are expressed in Global Positioning System Coordinates, GPS coordinates, then the relative distance X2 may hence be calculated by taking the Haversine Formula between two GPS coordinates to compute the distance between the two devices. The relative direction, X2, may be calculated by taking the angle difference between the connecting devices followed by a modulus of congruence with base value 180. For example, if a connecting device is facing an angle of 25 degrees with reference to Azimuth, and the other connecting device is facing an angle of 300 degrees with reference to Azimuth, then the relative direction, X2, is computed by taking the absolute value of |25−300| and then (mod 180). This is equivalent to |275| (mod 180), which is 95 (mod 180). The relative direction, X2, between the two connecting devices is thus 95 degrees.

Step 1120 is “For every “user intended” dataset, assign an output value, Y=1 to the predictor input dataset; for every “non-user intended” dataset, assign an output value, Y=0 to the predictor input dataset.” A “user intended” or “non-user intended” dataset may be defined as the dataset corresponding to the user's spontaneous intention at the time when that particular dataset was logged. For instance, when two users's spontaneous intention at the point of establishing a device connection at an arbitrary relative distance of 15 metre, X1=15, and at an arbitrary relative direction of 120 degrees, X2=120, was an intended pair, i.e., “User intended” case, then assign the value of Y=1 to that dataset. The dataset is hence (X1=15, X2=120, Y=1). Wherein if the users' spontaneous intention at the point of establishing a device connection was not intended, i.e., “Non-user intended” case, then assign the value of Y=0 to that dataset. The dataset is then (X1=15, X2=120, Y=0).

Step 1130 is “Compiling a table of predictor input datasets, X₁ and X₂ with corresponding output, Y, that takes the value of either 1 or 0. i.e., (“user intended”, Y=1”) or (“non-user intended”, Y=0).” Table 12 illustrates an example of table that comprises of predictor input X1, and X2, with its corresponding assignment of output, Y. Each row of dataset contributes one term to the likelihood. We can then use a numerical algorithm to generate a maximizer that gives a best estimate of parameter values of a logistic regression sigmoid function. While Table 12 only serves to show an examples of dataset with arbitrarily assigned values, the table is definitely not meant to be exhaustive nor the assigned values meant to be restrictive. Those skilled in the arts may appreciate the fact that by filtering or changing the values in the table, or by extending the table to a significantly large numbers of datasets increases the accuracy of the user predictive model 340 because more datasets contributes more terms to the computation of likelihood, and also more accurate datasets contributes to more accurate computation of likelihood as well. The table 12 may also be extended by adding theoretical datasets to complement the experimental datasets. For instance, in a relative distance of 30 metre, i.e., X1=30, and relative direction 180 degrees, i.e., X2=180, the experimental dataset may have an assigned output value of “User Intended” case, i.e., Y=1. Hence the experimental dataset is {X1=30, X2=180, Y=1}. We can extend the experimental dataset by adding a complementary theoretical dataset that essentially illustrates the point on “larger relative distance value, X1, will result in a “Non-user intended” case, i.e., by adding a theoretical dataset of {X1=130, X2=180, Y=0}. Notice that The X1 value was extended by 100 metre, while keeping the X2 value constant, and output value is toggled to 0. Those skilled in the arts may appreciate the fact that by adding theoretical datasets to complement the experimental datasets makes the device pairing system “smarter” because the each newly added theoretical dataset also contribute one term to the likelihood. The added term to the likelihood highlights the individual degree of influence each predictor input, X1, or X2, has on the output Y.

Step 1140 is “Constructing a sigmoid function using logistic regression and compute its parameter values.” From the compiled table of predictor input datasets, X1 and X2 with corresponding output, Y, each dataset contributes one term to the likelihood. For example, given a dataset of (Relative distance, X1=30 metres, and relative direction, X2=180 degrees, with and known outcome that is “User Intended”, Y=1), we then have the dataset (x1=30, x2=180, Y=1), we will then have a contributing term ê{b0+b1*30+b2*180}/(1+ê{b0+b1*30+b2*180}). Thus the likelihood is just the product of all such terms (the number of terms is the same as the number of observations or datasets). Once we have the likelihood, which involves b0,b1,b2, we can then maximize the likelihood, which is a function of b0,b1,b2 to get the estimates of b0,b1,b2. There is no close form solution to this optimization problem but we could use numerical algorithms that could generate the maximizer to obtain the estimates in logistic regression. Obtaining the estimates in logistic regression may comprises using Maximum likelihood estimation, Likelihood ratio test, or any other algorithm generating function capable of relating the predictor input values to the output values.

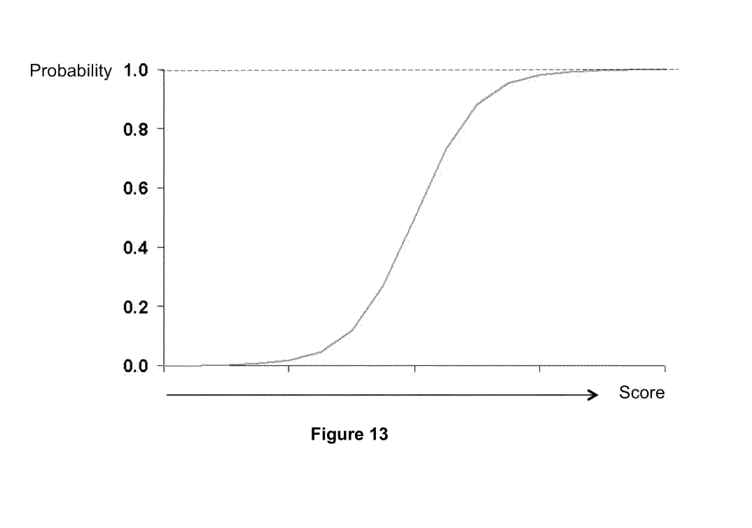

FIG. 13 illustrates the result of a sigmoid function generated using logistic regression. The sigmoid function takes the form of a “S” shape and returns a probability that predicts the pairing intention between two devices based on an user intention score on the X-axis, the user intention score is a function of relative distance and relative direction. i.e., an arbitrary combination of relative distance value and relative direction value outputs an user intention score on the X-axis. An arbitrary value of user intention score on the X-axis then corresponds to an arbitrary value of user pairing intention probability that ranges from 0.00 to 1.00 on Y-axis. The sigmoid function that take the form “S” shape and relates the arbitrary combination of relative distance value and relative direction value to the user pairing intention probability is hence the user predictive model 340.

Now that we have discussed how the user predictive model 340 is constructed, let us now turn our attention to how the user predictive model 340 helps to quantize user pairing intention when the server 200 receives a pairing information 300 from a device 210.

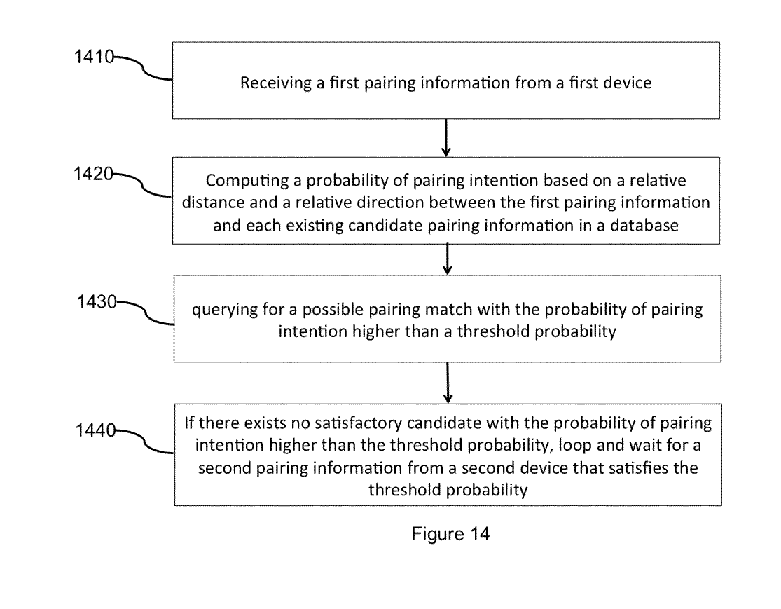

FIG. 14 illustrates the complete step process of intention-based device pairing validation. Step 1410 is “Receiving a first pairing information from a first device”. An user who intends to establish a connection with an intended target device or object, points the device in the direction of the intended device or object and initiates a pairing request. A server 200 is programmed to receive the first pairing information from the first device, which comprises of a location 310, a direction 320 and an optional information 330.

At step 1420, the server 200 computes a list of relative location and relative direction between the first pairing information and each existing pairing information in the server 200. Using an user predictive model 340, the server 200 then computes a probability of pairing intention between the first pairing information and each of the existing pairing information in the server 200. The probability of pairing intention is calculated by taking the relative location and relative direction as predictor inputs, X1, and X2 respectively, and returns the probability of pairing intention. The relative location and relative direction hence is an indicator that tells the likelihood of the user's intrinsic intention to establish a connection with each of the existing pairing information in the server 200, in terms of probability value that ranges from 0.00 to 1.00. Hence, step 1420 is “Computing a probability of pairing intention based on a relative distance and a relative direction between the first pairing information and each existing candidate pairing information in a database”. Notice that only a first pairing information from a first device is sufficient to start computing the pairing probability with the existing candidate pairing information in server 200. While device pairing usually involves two devices each sending a pairing information to the server to determine a match, this mechanism creates a possibility that the first device is trying to pair with an existing candidate pairing information in the server 200, i.e., A candidate pairing information associated to a passive device or object that is pre-calibrated or pre-assigned with a location value and a direction value in the server 200. In an embodiment, the first device may be trying to connect to a passive Point-of-Sales device located at a checkout counter for payment, in which case, the passive device stationed at the point-of-sales checkout counter is not required to actively participate in a pairing process, instead, the passive device just need to be pre-calibrated or having a pre-assigned location value and a direction value stored in the server 200, the server 200 will return a probability of the pairing intention between the first device and the candidate device. In an alternative embodiment, wherein the first device may be trying to connect to an active second device capable of reporting an updated location value and an updated direction value to the server 200. In which case, the first device points in the direction of the second device, and the second device points in the direction of the first device, and both devices initiate a pairing request with each other. The pairing request sends the location value and direction value of the first device and second device to the server 200. A probability of pairing intention is then computed between the first device and second device. The first device or second device may be a mobile phone, a computer, a laptop, a tablet, a web browser, a website, or a wearable technology such as spectacle device or watch device capable of reporting its current location and/or current direction.

Step 1430 is “querying for a possible pairing match with the probability of pairing intention higher than a threshold probability”. The threshold probability is a boundary that defines acceptable combinations of relative location value and relative direction value in which the connecting devices needs to fulfill in order to be consider a valid attempt of pairing intention. i.e., probability more than 0.5. To fulfill the threshold probability, the connecting devices' pairing information must comprise of a location 310 and a direction 320 such that the location 310s are sufficient close together and that the direction 320s are sufficiently “opposite in direction”. We have discussed earlier how adding theoretical datasets onto experimental datasets in Table 12 strengths the logistic regression and makes the user predictive model 340 “smarter” because it outlines the individual degree of influence each predictor input, X1, or X2, has on the output Y. Imaginably, the added theoretical datasets strength the fact that devices that are further apart has a lower probability of pairing intention but may be sufficiently compensated by a relative direction value that are extremely “opposite in direction”, similarly, devices that are not exactly “opposite in direction” will result in lower probability of pairing intention but may be sufficiently compensated by being extremely close together. The threshold probability is hence that compensation boundary that encircles these combination of devices' relative location values and relative direction values such that the joint compensation of the relative location values and relative direction values returns a probability high enough to be considered as a valid attempt to establish a connection with each other.

Step 1440 is “If there exists no satisfactory candidate with the probability of pairing intention higher than the threshold probability, loop and wait for a second pairing information from a second device that satisfies the threshold probability”. In an embodiment, an active first user wants to establish a connection with another active second user, the first user points his device in the direction of the second user, and initiates a pairing. The first device sends the first pairing information 300 to the server 200 but returns no satisfactory candidate devices in server 200. This is obvious because the server 200 contains no candidate pairing information yet. However, the server 200 loops and waits for a second pairing information from a second device that could satisfy the threshold probability. This is when the second user points his device in the direction of the first user, and initiates a pairing request, despite initiated at a later time than the first user. The second device then sends the second pairing information 300 to the server 200 and returns the first user device as a satisfactory candidate. The loop and wait component in step 1440 then allows the server 200 to loop the search for each pairing request in finding a candidate pairing device with the probability of pairing intention higher than the threshold probability.

As we have discussed, efficient and accurate intention based device pairing validation is a necessary part to establish a connection between an electronic devices with another device/object. As one skilled in the art will readily appreciate from the disclosure of the embodiments herein, processes, means, methods, or steps, that perform substantially the same function or achieve substantially the same result as the corresponding embodiments described herein may be utilized according to the present invention. Accordingly, the appended claims are intended to include within their scope such processes, means, methods, or steps.

The above description of illustrated embodiments of the systems and methods are not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize.

1. A method of intention based device pairing validation, the method comprises of a server capable of:
receiving a first pairing information from a first device;
computing a pairing probability based on a relative distance and a relative direction between the first pairing information and each existing candidate pairing information in a database;
querying for a possible pairing match with the probability of pairing intention higher than a threshold probability; and
If there exists no satisfactory candidate with the probability of pairing intention higher than the threshold probability, loop and wait for a new incoming second pairing information from a second device that satisfies the threshold probability.

2. The method of claim 1 wherein the first pairing information comprises of a location information and a direction information associated to the first device.

3. The method of claim 1 wherein the first pairing information may also comprises of an additional information such as ambient light, proximity sensor, sound, temperature, accelerometer, gyroscope sensor information.

4. The method of claim 1 wherein the first device and second device are pointing in a direction opposite of each other.

5. The method of claim 1 wherein the first device and second device are pointing at an angle relative to each other.

6. The method of claim 1 wherein the computing of the pairing probability comprises steps:
receiving a location information and a direction information from a first device;
computing a relative distance value and a relative direction value, based on the location information and the direction information of the first device and each of the location information and direction information of existing candidate devices in a database;
feeding the relative distance value and the relative direction value as predictor inputs into a logistic regression sigmoid function; and
returning a probability of pairing intention between the first device and each of the existing candidate devices in the database.

7. The method of claim 6 wherein the logistic regression sigmoid function may be constructed using experimental datasets comprising of:
a relative distance predictor input;
a relative direction predictor input; and
an assigned binary output that takes the value of either 0 or 1.

8. The method of claim 6 wherein the logistic regression sigmoid function may be constructed using theoretical datasets comprising of:
a relative distance predictor input;
a relative direction predictor input; and
an assigned binary output that takes the value of either 0 or 1.

9. The method of claim 1 wherein the second pairing information from the second device may be received by the server after the first pairing information had been received.

10. Method for establishing communications between a first device and a second device/object, wherein the communication comprises steps of:
receiving a first pairing information from the first device; based on the first pairing information and an existing second pairing information associated to the second device/object in a server database, determining:
If the first device is sufficiently close to the second device/object;
If the first device is pointing in a direction sufficiently opposite to the second device/object; and
if the first device is indeed sufficiently close and pointing in a direction sufficiently opposite to the second device/object, sending a pairing valid to both the first device and the second device/object.

11. The method of claim 10, wherein the pairing information comprises of a location information and a direction information associated to the device.

12. The method of claim 10, wherein the second device/object may be a passive non-electronic device with pre-assigned or pre-calibrated location value and direction value stored in a server database.

13. The method of claim 10, wherein the second device/object may be a banner, an advertisement space, a store, a building, a location, or any other physical locations where a location value and a direction value may be assigned to it in a server database.

14. The method of claim 10 wherein the second device/object is configured to send an updated pairing information to the server database.

15. The method of claim 10, wherein the pairing information may comprises of an updated current location information and current direction information associated to the second device/object.

16. The method of claim 10, wherein the second device/object may be a personal computer, a laptop, a tablet, a phone, a web browser, a web site, a wearable technology such as spectacle device or watch device, capable of sending an updated current location value and/or an updated direction value to the server database.

17. The method of claim 10 wherein the first device or the second device/object may be a mobile phone.

18. The method of claim 10 wherein the first device or the second device/object may be wearable technology such as a spectacles device, or a watch device.
